(19) United States
(12) Patent Application Publication
(10) Pub. No.: US 2026/0289702 A1
(43) Pub. Date: Sep. 24, 2026

(54) SYSTEMS AND METHODS FOR PROVIDING GUIDED INTERACTIONS

(71) Applicant: Iris Jones, Baltimore, MD (US)

(72) Inventor: Iris Jones, Baltimore, MD (US)

(21) Appl. No.: 19/557,507

(22) Filed: Mar. 5, 2026

Related U.S. Application Data
(60) Provisional application No. 63/767,389, filed on Mar. 5, 2025.

(51) Int. Cl. G06Q 50/18; G06Q 50/26; H04L 9/00; H04L 9/40

(52) U.S. Cl. CPC G06Q 50/18; G06Q 50/265; H04L 9/50; H04L 63/0428

(57) ABSTRACT

A system for providing jurisdiction-aware legal guidance during user interactions comprises a user computing device with a processor, camera, microphone, and global positioning system receiver, and a system server in communication with the user computing device. A legal database comprises jurisdiction-specific legal rules indexed by geographic region. A geospatial intelligence ledger comprises anonymized incident metadata indexed by geographic coordinates. The user computing device captures audio data, visual data, and positional data comprising geographic coordinates and timestamps, and transmits the data to the system server. The system server queries the geospatial intelligence ledger using the geographic coordinates to retrieve location-specific incident metadata, filters the legal database based on the geographic coordinates to generate a pruned legal dataset comprising only jurisdiction-specific legal rules applicable to a jurisdiction corresponding to the geographic coordinates, analyzes the audio data, visual data, and positional data to generate a contextual assessment, applies a legal weighting algorithm to the contextual assessment, the location-specific incident metadata, and the pruned legal dataset to generate prioritized guidance, and transmits the prioritized guidance to the user computing device for presentation via a user interface.

### CROSS-REFERENCE TO RELATED APPLICATION

This patent application claims the benefit of priority under 35 U.S.C. § 119 to U.S. Provisional Patent Application No. 63/767,389, filed Mar. 5, 2025, and entitled “SYSTEMS AND METHODS FOR PROVIDING GUIDED INTERACTIONS,” which is incorporated herein by reference in its entirety.

### TECHNICAL FIELD

The present disclosure is related to systems and methods for providing real-time, jurisdiction-aware legal guidance and forensic evidence preservation during high-stress human interactions. In particular, the present disclosure relates to systems and methods to improve the functioning of computational technologies related to artificial intelligence, multimodal sensor fusion, and secure cloud-based data architectures by integrating geolocation-aware legal intelligence engines, natural language processing pipelines, cryptographically secured evidentiary capture mechanisms, and crowdsourced geospatial intelligence ledgers to deliver context-sensitive, rights-assertion guidance and tamper-resistant incident documentation to users engaged in legally significant encounters, such as interactions with law enforcement.

The present invention is directed to advanced systems, methods, and devices that are designed to provide users with real-time guidance, assistance, and legal support during real-world interactions, specifically focusing on high-stress or legally complex situations, such as encounters with law enforcement. These systems integrate artificial intelligence (AI) components with data processing algorithms to analyze the situation, offer context-sensitive advice, and generate immediate, personalized recommendations based on the user's specific circumstances. Additionally, the system is capable of activating multi-device recording capabilities-such as connecting to dash cams, phone cameras, and other external recording devices-to document the interaction and ensure an accurate record is maintained for accountability purposes. Embodiments may also feature a social media aspect, integrating live-streamed and recorded interactions directly into the platform, where users can share experiences, access legal resources, and engage with a community of like-minded individuals. It provides a unique combination of real-time legal assistance and social engagement, empowering users with the tools they need to protect themselves and fostering dialogue about justice and accountability. This technology represents a significant advancement in providing accessible legal assistance, tailored specifically to scenarios where individuals are most vulnerable to potential legal violations or abuses of power.

### BACKGROUND

People often find themselves in situations where they lack the knowledge or context to navigate successfully. This is particularly true during interactions with law enforcement, where many individuals are uncertain about their rights and what they can say. This uncertainty can lead to misunderstandings, heightened tension, and even escalation, leaving individuals vulnerable in moments when they should feel protected. The need for guidance also extends to other scenarios, such as negotiating with a car salesman, where individuals may feel pressured and unaware of their rights and options. In these high-stress encounters, the absence of guidance can result in negative experiences, whether through violations of rights or unfair deals. What is needed is a tool that provides real-time guidance, empowering individuals to confidently and safely navigate various interactions.

### SUMMARY OF THE INVENTION

Embodiments consistent with the present disclosure include an interactive guided interaction tool. The guided interaction tool, which may also be referred to herein as “Just-Us,” may be an app operating on a mobile device and interfacing with a back-end server. The various capabilities of the system as described herein may be operational on either the mobile device or the server, in any combination. The guided interaction tool may include AI components configured to empower and assist individuals during high-stress interactions. Just-Us guides users through encounters, offering real-time assistance on their rights and best practices. In embodiment, the guided interaction tool may communicate on the user's behalf. The guided interaction tool may make use of a camera integrated with the mobile device and may include social media aspects, such as the ability to live streams interactions. Such social media ability may ensure accountability and may further create a dedicated platform where users can share their experiences. This social media aspect brings together recorded encounters and real-time events, fostering a community of like-minded individuals who provide support, engage in discussions, and promote justice.

### BRIEF DESCRIPTION OF THE DRAWINGS

The accompanying figures, which are incorporated herein, form part of the specification and illustrate embodiments of systems, methods, and devices for real-time guided interactions using artificial intelligence components. Together with the description, the figures further explain the principles of and enable a person skilled in the relevant art(s) to make and use the methods, systems, and devices described herein. The drawings are provided to illustrate various features of the embodiments described herein and are not necessarily drawn to scale. In the drawings, like reference numbers indicate identical or functionally similar elements.

FIG. 1 illustrates a use-case scenario for a system configured for providing guided interactions using artificial intelligence, integrating multi-device connectivity for real-time interaction guidance and recording.

FIG. 2 illustrates an example networking environment comprising a system server, user computing devices, data retention systems, emergency services, and network connections consistent with the present disclosure.

FIG. 3 illustrates an embodiment of a user computing device architecture comprising a processor, storage device, and software modules including a user interface manager, speech-to-text manager, data storage manager, decision tree manager, and network manager.

FIG. 4 illustrates an embodiment of a system server architecture comprising a processor, storage device, and software modules including an interaction analysis module, legal guidance module, and user communication module.

FIG. 5 illustrates a breakdown of the interaction analysis module comprising an event classification and escalation module, speech capture and transcription module, and visual evidence capture and analysis module.

FIG. 6 illustrates a breakdown of the legal guidance module comprising a real-time legal guidance engine and jurisdictional data intelligence module.

FIG. 7 illustrates a breakdown of the user communication module comprising a rights assertion module, legal interface trigger module, emergency command module, personalization and instruction history module, and device integration control module.

FIG. 8 illustrates a flowchart of multimodal data capture and law enforcement interaction detection, beginning with initiation of data capture and proceeding through speech recognition, multimodal context analysis, visual evidence analysis, passive monitoring, and identification of law enforcement interaction, culminating in encounter classification and risk assessment.

FIG. 9 illustrates a continuation of the flowchart from FIG. 8, showing encounter classification and legal response workflow, including jurisdictional law selection, user profile-driven legal context application, rights assertion evaluation, legal guidance generation, officer compliance evaluation, device control and evidence collection, emergency escalation decision-making, lawyer interface initiation, and delivery of legally contextualized advisory responses.

FIG. 10 illustrates a flowchart depicting a computer-implemented method for preserving forensic integrity of multimodal evidence.

FIG. 11 illustrates a flowchart depicting a computer-implemented method for multimodal intent fusion in legal encounter scenarios.

### DETAILED DESCRIPTION

The following detailed description is provided to enable any person skilled in the art to make and use the disclosed subject matter. Various modifications, equivalents, and variations will be apparent to those skilled in the art, and the general principles defined herein may be applied to other embodiments and applications without departing from the scope of the disclosure. The detailed description is not intended to limit the scope of the subject matter, which is defined solely by the appended claims. The present disclosure provides systems and computer-implemented methods for real-time contextual incident assistance, jurisdiction-aware legal guidance generation, and forensic evidence preservation during high-stress or legally significant user interactions. In particular, the systems and methods described herein serve to improve the functionality of computers and computer hardware that implement artificial intelligence systems and machine learning models. The functionality may be improved by providing multimodal data that may be processed more efficiently through structured normalization, temporal alignment, and jurisdiction-specific pruning, thereby providing faster and more accurate guidance outputs.

Individuals engaged in high-stress or legally significant encounters face a set of compounding technical problems that existing computing systems fail to address. A first problem may arise from the cognitive limitations of individuals under stress. During a traffic stop, for example, a user computing device 201 may capture audio data via a microphone 302 and visual data via a camera 301, yet the user may be unable to recall applicable legal rights or formulate legally appropriate responses in real time. Existing systems do not provide automated, context-sensitive rights assertion or real-time legal guidance tailored to the specific circumstances of the encounter.

A second problem may arise from the fragmented and unverified nature of existing encounter documentation methods. During an active session, the user computing device 201 may capture audio data via the microphone 302 and visual data via the camera 301 from multiple sources, yet existing systems may lack the capability to cryptographically secure such data in a tamper-evident manner suitable for forensic use.

A third problem may arise from the absence of jurisdiction-aware legal filtering. Existing systems may fail to provide users with appropriate understanding of the legal framework in place in the user's current location. Solutions provided by embodiments herein may include dynamically pruning a global legal database to retain only those statutes, regulations, and procedural rules applicable to a user's verified geographic coordinates, thereby producing guidance that may be legally inapplicable or misleading.

A fourth problem may arise from the absence of aggregated information about risk in a specific area. This may be addressed by aggregated geospatial intelligence. Existing platforms may lack the capability to anonymize and index incident metadata by geographic coordinates, thereby failing to provide location-specific risk profiles or pre-incident alerts to users approaching high-volatility zones.

The present disclosure provides a technical solution to each of the above-described technological problems by providing multimodal data capture, jurisdiction-specific database pruning, cryptographic chain-of-custody preservation, and crowdsourced geospatial intelligence aggregation, each of which may be implemented across the system components described herein, including the user computing device 201, the system server 200, and the data retention systems 190, as further described below.

The systems and methods described herein may provide a number of technical advantages over prior art approaches. A first technical advantage may arise from the jurisdiction-aware database pruning operation performed by the system server 200. Conventional systems may apply a global legal dataset without geographic filtering, producing guidance that may be legally inapplicable to a user's verified location. The present system may reduce the scope of the legal database to only those statutes and regulations applicable to the user's GPS-verified jurisdiction, thereby reducing computational overhead and increasing the precision of generated guidance. A second technical advantage may arise from the cryptographic chain-of-custody architecture implemented by the Automated Forensic Orchestration Layer. Prior art recording methods may produce unverified, mutable records. The present system may apply SHA-256 hashing and write-once-read-many storage to produce tamper-evident forensic records suitable for legal proceedings. A third technical advantage may arise from the transformer-based multimodal fusion architecture, which may combine audio, visual, and positional data streams into a unified probabilistic encounter classification, thereby enabling more accurate guidance generation than single-modality prior art systems. A fourth technical advantage may arise from the geospatial intelligence ledger, which may aggregate anonymized incident metadata across multiple users to generate location-specific risk profiles unavailable to prior art platforms.

As used herein, “guided interaction” refers to a computer-implemented process by which a system analyzes real-time multimodal input data and generates context-sensitive outputs that assist a user in navigating a high-stress or legally significant encounter. A guided interaction may include, but is not limited to, a traffic stop, a law enforcement detention, an investigatory stop, an arrest, a regulatory inspection, a commercial negotiation, a car accident scene interaction, a courtroom proceeding, or any other encounter in which a user may benefit from real-time legal information, rights assertion support, or automated documentation.

As used herein, “multimodal data” refers to data acquired from two or more distinct sensor modalities associated with a user computing device or one or more external sensor systems. Multimodal data may include, but is not limited to, audio data captured by one or more microphones, visual data captured by one or more cameras or imaging sensors, positional data captured by one or more global positioning system (GPS) or global navigation satellite system (GNSS) receivers, motion data captured by one or more inertial measurement units (IMUs), and telemetric data captured by one or more vehicle-integrated or Internet-of-Things (IoT) sensors, or any other form of sensor-derived data, whether captured on a mobile device, a wearable device, a vehicle-mounted device, or an external recording device.

As used herein, “jurisdiction-specific legal data” refers to codified statutes, constitutional provisions, regulations, local ordinances, procedural rules, enforcement policies, case law citations, and related legal metadata that may be applicable to a particular geographic region. Jurisdiction-specific legal data may include, but is not limited to, federal law, state law, municipal law, traffic regulations, search and seizure standards, detention and arrest procedures, firearms disclosure requirements, speed limit data, school zone designations, and border enforcement zone parameters, or any other form of legal rule indexed by geographic coordinate, jurisdiction identifier, or effective date.

As used herein, “forensic evidence record” refers to a collection of captured multimodal data segments that have been cryptographically processed and stored in a manner configured to preserve evidentiary integrity. A forensic evidence record may include, but is not limited to, timestamped audio fragments, timestamped video fragments, positional data series, cryptographic hash values, digital signatures, chain-of-custody log entries, session identifiers, and associated metadata, or any other form of tamper-evident data structure suitable for use in legal proceedings or dispute resolution.

As used herein, “geospatial intelligence” refers to aggregated, anonymized incident metadata that has been indexed by geographic coordinates and made available for use in priming artificial intelligence guidance systems. Geospatial intelligence may include, but is not limited to, incident frequency data, encounter type classifications, risk level scores, legal violation flags, officer misconduct indicators, sentiment tags, speed trap location data, school zone boundary data, and policy heat map data, or any other form of location-indexed community-sourced encounter information.

As used herein, “artificial intelligence” (AI) refers to a wide variety of methods and systems, including, but not limited to, machine learning algorithms and systems. Suitable machine learning systems and algorithms may include, for example, supervised learning models, unsupervised learning models, reinforcement learning models, deep learning neural network models such as feedforward neural networks (FNNs), convolutional neural networks (CNNs), and recurrent neural networks (RNNs), transformer-based models including at least large language models (LLMs), generative models, hybrid or specialized models, etc.

As used herein, “real-time” refers to a level of responsiveness or processing that occurs with a delay that may be sufficiently short to enable a system, device, or user to perceive or process results on an ongoing basis with respect to triggering events. The precise timing may vary depending on the context and does not require instantaneous operation or zero latency. For example, in the context of real-time guidance generation, “real-time” refers to the ability of the system to receive multimodal data, process that data through artificial intelligence components, and transmit guidance outputs to a user computing device while the user continues to engage in the interaction, such that there may be no or insignificant buildup of unprocessed data. Although there may be latency between a triggering event and the receipt and processing of the associated multimodal data, the receipt and processing may occur at substantially the same rate, for example within five percent, within three percent, or within one percent, of the rate at which the triggering events are occurring.

Multimodal data acquired during real-world encounters may be an example of a real-world data source that may be irregular, unstructured, noisy, and heterogeneous. Audio data captured during a high-stress interaction may include, for example, overlapping speech from multiple speakers, ambient environmental noise, vehicle sounds, and variable acoustic conditions that may degrade signal quality. Visual data captured during such interactions may include variable lighting conditions, motion blur, partial occlusion of objects of interest, and inconsistent frame rates across multiple connected recording devices. Positional data may include GPS signal degradation in urban canyons or indoor environments, clock synchronization discrepancies across heterogeneous sensor sources, and gaps in telemetric continuity resulting from network interruptions. Existing approaches to processing such data for use in artificial intelligence systems may rely on single-modality inputs, static feature representations, or pre-processed datasets that fail to preserve the temporal dynamics and contextual relationships present in live, multi-source interaction data. Such approaches may fail to capture the legally significant behavioral patterns, acoustic escalation indicators, and visual entity identifications that may be present in real-time encounter data, leading to limited guidance accuracy and reduced evidentiary utility.

Furthermore, existing systems for providing legal guidance during high-stress interactions may rely on static, pre-loaded legal content that may not be dynamically filtered to reflect the specific geographic jurisdiction in which a user encounter may be occurring. A global legal database that may be applied without jurisdiction-specific pruning may introduce irrelevant legal rules into the guidance generation process, increasing computational overhead and reducing the precision of guidance outputs. Existing documentation methods may produce unverified, mutable records that may be subject to post-capture modification, limiting their admissibility and reliability in legal proceedings. Existing platforms for aggregating community encounter data may be unstructured and disconnected from verified evidentiary records, limiting their utility for priming artificial intelligence responses or generating pre-incident alerts. The absence of integrated systems that may combine real-time multimodal data processing, jurisdiction-specific legal intelligence, cryptographically secured forensic preservation, and community-sourced geospatial intelligence may present a technical gap in current solutions. The present disclosure provides a technical solution to the above-described technological problem. The present disclosure serves to improve the functioning of computers and computer hardware operating artificial intelligence systems by increasing the efficiency and accuracy of such systems through the multimodal normalization, jurisdiction-specific database pruning, temporal alignment, and cryptographic preservation techniques provided herein.

Some methods of prior art legal guidance systems may rely on keyword-triggered static response libraries, such as pre-written scripts indexed by a limited set of predefined terms, into fixed outputs with no contextual adaptation. Such approaches may fail to preserve the dynamic legal context and situational risk patterns that may evolve over the course of a real-world encounter. These approaches may struggle to capture the probabilistic encounter type classifications, jurisdiction-specific rights assertion requirements, and multimodal escalation indicators that may be present in live interaction data, leading to limited guidance relevance, especially in encounters involving multiple overlapping legal frameworks or rapidly changing situational conditions.

In contrast, the present system may apply a transformer-based multimodal fusion architecture to combine audio transcript data, visual entity detection outputs, and positional data into a unified probabilistic encounter representation, enabling the use of advanced natural language processing and computer vision techniques to extract legally significant features such as encounter type classifications, risk level scores, and rights-triggering keyword detections. These features may retain the rich contextual characteristics of real-world encounter data, which may then be applied through a legal weighting algorithm for more accurate jurisdiction-specific guidance generation. While transformer-based architectures may be used in domains such as natural language processing or image classification, their application to real-time multimodal legal encounter analysis may be highly unconventional and not previously deployed in practical guided interaction systems. The integration of multimodal fusion methods into the legal guidance generation pipeline for real-time rights assertion and forensic evidence preservation may represent a significant engineering advancement, offering improved accuracy, interpretability, and generalizability, and representing an unexpected and non-obvious advancement over conventional prior art approaches.

The present disclosure provides systems and methods for several aspects of methodologies useful in real-time guided interaction and forensic evidence preservation. First, the use of a jurisdiction-specific database pruning operation, whereby a global legal database may be dynamically reduced to a session-specific applicable legal rule set by discarding statutes and regulations irrelevant to a user's verified GPS location, demographic attributes, and encounter type, may provide a technical solution to the technological problems associated with processing large, heterogeneous legal datasets in real time on resource-constrained mobile computing devices. Such pruning may be especially useful when the applicable legal framework may span multiple hierarchical jurisdiction levels, including federal, state, and local law. Additionally, the specific application of cryptographic hashing and write-once-read-many storage architecture to discrete, fixed-duration multimodal media fragments, particularly when combined with a centralized time-stamping authority and a chain-of-custody log, may provide a significant advancement in the preservation of forensically sound evidentiary records suitable for legal proceedings. Finally, the aggregation of anonymized incident metadata from multiple users into a geospatially indexed ledger, and the use of that ledger to prime artificial intelligence guidance responses and generate pre-incident alerts for users approaching high-volatility geographic zones, may provide significant improvements to the technological environment of employing machine learning algorithms to real-time legal guidance tasks. The combination of multimodal fusion techniques, jurisdiction-specific legal intelligence, cryptographic forensic preservation, and community sourced geospatial intelligence described by the present specification may represent an advantageous interdisciplinary advancement.

The following detailed description is merely illustrative in nature and is not intended to limit the invention or the application and uses of the invention. Although the description of the invention is in the context of systems, methods, and devices for facilitating guided user interactions, the disclosure should not be considered so limiting. For example, although systems, methods, and devices may be discussed herein with respect to law enforcement interactions, the invention can be applied to various high-stress situations where real-time guidance and legal support are needed, such as car crashes, interactions with car salesmen, courtroom proceedings, legal negotiations, or emergency services. Modifications may be made to the embodiments described herein without departing from the spirit and scope of the present invention. Therefore, the following detailed description is not meant to be limiting. Furthermore, there is no intention to be bound by any expressed or implied theory presented in the preceding technical field, background, summary, or the following detailed description. The present disclosure addresses the issues outlined above. The disclosure relates to systems, methods, and devices that provide real-time (or near real-time) guidance, legal advice, and documentation support during high-stress situations, such as interactions with law enforcement, car crashes, or negotiations with car salesmen. The invention integrates artificial intelligence to analyze the context of the interaction, offer real-time advice, and activate recording devices to ensure accountability. By providing users with immediate, situation-specific recommendations and guidance, the system empowers individuals to navigate complex interactions confidently and safely.

Embodiments disclosed herein may facilitate real-time assistance and support for users during various high-stress interactions. The system provides immediate, context-sensitive guidance tailored to the specific situation, enabling individuals to navigate encounters with law enforcement, manage car accidents, or negotiate with car salesmen confidently. When a user activates the app, it analyzes the interaction and offers relevant information about their rights and best practices. The system does this through an intuitive interface that guides users with voice prompts and visual cues, ensuring they remain informed throughout the encounter. Additionally, it activates connected recording devices—such as dash cams and smartphone cameras—to document the interaction, creating a reliable record for accountability purposes.

In some embodiments, the system may perform an initial contextual onboarding process when a user first activates the guided interaction tool. This onboarding process may generate a baseline operational profile for the predictive logic engine by transforming jurisdiction-specific metadata, verified geolocation information, and user-associated parameters into a user-specific logic profile. The onboarding process may prompt the user to provide demographic information, licensure data, and other relevant attributes that may influence legal guidance during interactions. The system may verify the user's geolocation using GPS coordinates and may cross-reference these coordinates with jurisdiction databases to identify applicable federal, state, and local legal frameworks. The user-specific logic profile may be stored in a secure user attribute vault and may be updated dynamically as the user's location or circumstances change. This contextual onboarding may enable the system to provide tailored guidance that accounts for the user's unique legal context and personal circumstances.

Unique to this system is its ability to speak on behalf of the user in certain scenarios, ensuring their voice is heard even under pressure. Additionally, the app serves as a social media platform, allowing users to share their experiences and learn from others in a supportive community. This dual functionality not only enhances individual safety but also fosters dialogue about legal rights and procedures, creating a more informed public. Overall, the system represents a significant advancement in personal safety and legal empowerment, bridging the gap between technology and real-world interactions in a commercially valuable manner.

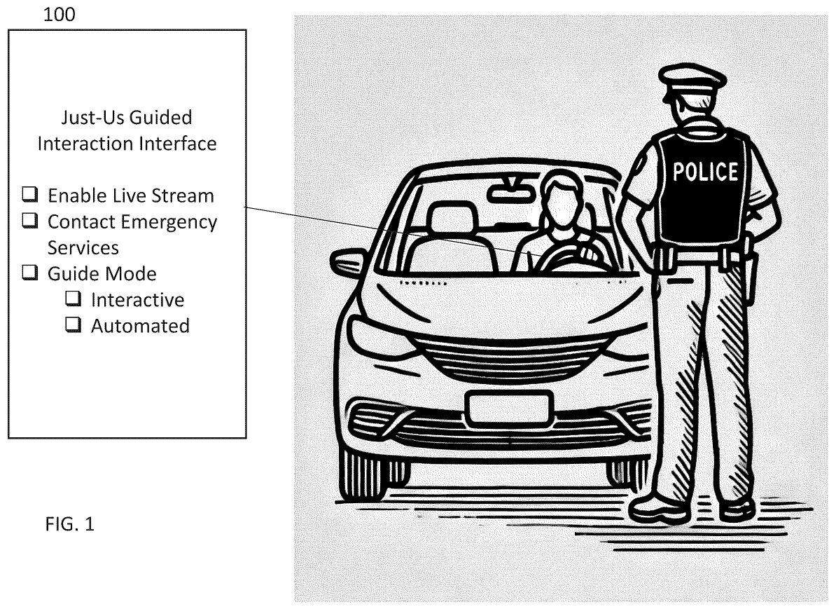

FIG. 1 illustrates one use case scenario consistent with the present disclosure. A user in a vehicle that has been pulled over by a law-enforcement officer is accessing the guided interaction tool interface 100. The guided interaction tool interface 100 may be activated verbally, via gesture, and/or via touch. As shown in FIG. 1, the user is notifying the guided interaction tool 100 that they have been pulled over, prompting their mobile device to display the Just-Us app interface. In embodiments, the guided interaction tool interface 100 may be operable through a car display screen either in conjunction with a user's mobile device or as service in the vehicle software. The image highlights a few of the various options available within the application, including livestreaming the interaction, contacting emergency services, and enabling the app to speak on the user's behalf in an automated mode or to provide a user with prompts in an interactive mode. This visual representation emphasizes how the Just-Us app integrates seamlessly with vehicle technology to provide immediate support and legal assistance during high-stress encounters with law enforcement. By showcasing this interaction, FIG. 1 contextualizes the technical details that follow, demonstrating the practical application of the system in empowering individuals when they need it most. The illustrated interface is provided by way of example only.

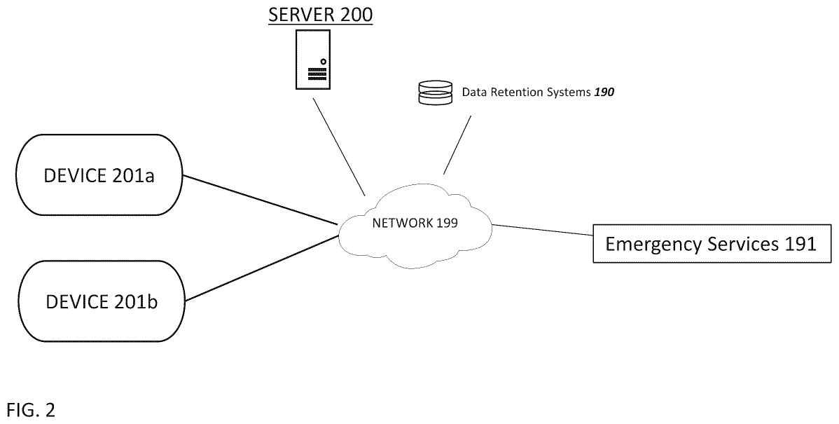

FIG. 2 illustrates a networking environment for the guided interaction tool, depicting how various components interact within the system. The figure showcases a central server 200 that may communicate with user devices 201a, 201b, such as smartphones and in-car systems, as well as external resources such as data retention systems 190 and emergency services 191. Data retention systems 190 may include, for example, any necessary external data resource, including, for example, legal databases. This network structure allows for real-time data processing and the delivery of immediate assistance during encounter, such as those with law enforcement personnel. In the system, user devices 201 connect to the central server 200 through secure internet protocols, enabling seamless communication and data exchange. The server 200 processes user input and contextual information, and may employ AI algorithms to provide tailored guidance based on the specific situation. In some embodiments, the user device 201 itself may perform the processing required to provide guidance. This setup ensures that users receive accurate and timely support, whether they are navigating a traffic stop or other high-stress interactions. Alternatively, if users have different hardware capabilities or network configurations, the system may be adapted accordingly. For example, if a user's smartphone lacks the processing power to run advanced AI functions, the system may utilize edge computing by shifting some processing tasks to the central server or to a cloud-based solution. This flexibility allows users to benefit from the features of the guide interaction tool, regardless of their individual device limitations, while ensuring that the core functionality remains intact.

Additionally, as technology advances, the potential to integrate more sophisticated AI capabilities directly into user devices may enhance the overall experience and effectiveness of the Just-Us app.

The network environment depicted in FIG. 2 represents an example embodiment of the guided interaction system. While it illustrates connections through network 199, a variety of individual or network connections can be utilized to facilitate the interaction between these systems. This flexibility allows for the integration of various devices and platforms, ensuring that users can access the Just-Us app's features regardless of their specific hardware or network setup. The network 199 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 2G, 3G, 4G, or 5G. Wireless standards may use various channel access methods, e.g., FDMA, TDMA, CDMA, or SDMA. In some embodiments, different types of data may be transmitted via different links and standards. In other embodiments, the same types of data may be transmitted via different links and standards. Network communications may be conducted via any suitable protocol, including, e.g., http, tcp/ip, udp, ethernet, ATM, etc.

The network 199 may be any type and/or form of network. The geographical scope of the network may vary widely and the network 199 can be a body area network (BAN), a personal area network (PAN), a local-area network (LAN), e.g., Intranet, a metropolitan area network (MAN), a wide area network (WAN), or the Internet. The topology of the network 199 may be of any form and may include, e.g., any of the following: point-to-point, bus, star, ring, mesh, or tree. The network 199 may be of any such network topology as known to those ordinarily skilled in the art capable of supporting the operations described herein. The network 199 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv4), or the link layer. The network 199 may be a type of broadcast network, a telecommunications network, a data communication network, or a computer network.

The data retention systems 190 may include any type of computer readable storage medium (or media) and/or a computer readable storage device. Such computer readable storage medium or device may be configured to store and provide access to data. Examples of computer readable storage medium or device may include, but is not limited to, an electronic storage device, a magnetic storage device, an optical storage device, an electromagnetic storage device, a semiconductor storage device, or any suitable combination thereof, for example, such as a computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick.

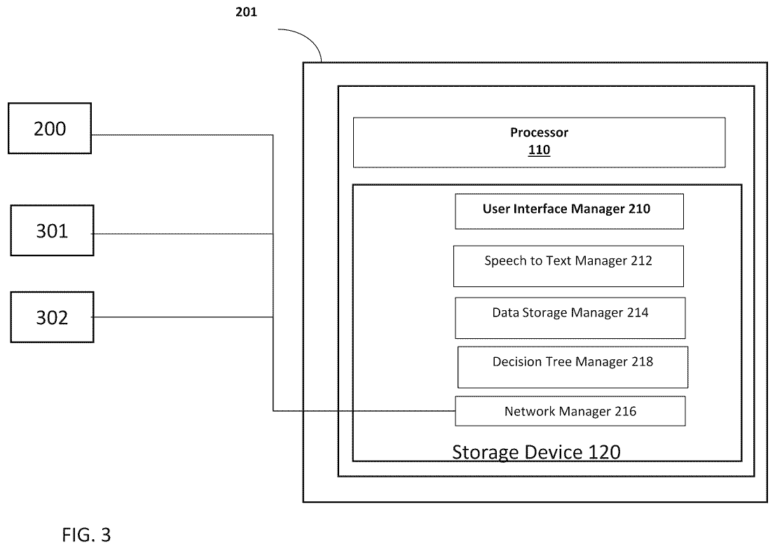

FIG. 3 illustrates a user device of a guided interaction system user device consistent with embodiments hereof. The guided interaction system user device 201 includes one or more processors 110 (also interchangeably referred to herein as processors 110, processor(s) 110, or processor 110 for convenience), one or more storage device(s) 120, and/or other components. In other embodiments, the functionality of the processor may be performed by hardware (e.g., through the use of an application specific integrated circuit (“ASIC”), a programmable gate array (“PGA”), a field programmable gate array (“FPGA”), etc.), or any combination of hardware and software. The storage device 120 includes any type of non-transitory computer readable storage medium (or media) and/or non-transitory computer readable storage device. Such computer readable storage media or devices may store computer readable program instructions for causing a processor to carry out one or more methodologies described here. Examples of the computer readable storage medium or device may include, but is not limited to an electronic storage device, a magnetic storage device, an optical storage device, an electromagnetic storage device, a semiconductor storage device, or any suitable combination thereof, for example, such as a computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, but not limited to only those examples.

The processor 110 is programmed with one or more computer program instructions stored on the storage device 120. For example, the processor 110 is programmed by various modules, including a User interface manager 210, a Speech to Text Manager 212, a Data Storage Manager 214, a Network manager 216, and a Decision Tree Manager 218, further explained below. The functionality of these modules is representative and not limiting. Additionally, the storage device 120 may serve as an additional data retention system 190, providing storage for user data and interaction history. For convenience, the various “managers” or “modules” will be described as performing operations; however, it is the programming of the processor 110 that enables the guided interaction system user device 201 to execute these operations.

The network manager 216 is a software protocol operating on the guided interaction system user device 201. The Network Manager (NM) 216 manages all network communications between the user device and external systems, such as cloud servers or other devices. It ensures that data is transmitted securely and efficiently. The NM 216 establishes communication pathways for all modules that require data transfer, particularly the Data Storage Manager 214 and the server-side modules, ensuring seamless integration and real-time updates.

The network manager 216 is designed to establish network communications between the guided interaction system user device 201, the various systems (e.g., server 200, camera 301, microphone 302, etc.) involved in the guided interaction, and the one or more data retention systems 190. This communication pathway may utilize any suitable network transfer protocol, facilitating either one-way or two-way data transfer as needed. The network manager 216 may establish multiple network connections to effectively communicate with the aforementioned systems, ensuring seamless data exchange and real-time updates during interactions. The network manager 216 may also establish local connections, e.g., within the same device, to obtain data captured by various components of the guide interaction system user device 201 (e.g., cameras and microphones).

The network manager 216 facilitates the sending and receiving of data between the user device and the various systems mentioned herein. This includes handling control instructions, such as commands generated for specific actions during interactions, ensuring that users receive timely guidance and support. The network manager 216 further ensures efficient communication, enabling real-time updates and responses that enhance the overall functionality and user experience of the guided interaction system.

The user interface manager 210 is a software protocol operating on the guided interaction system user device 201. The User Interface Manager (UIM) 210 is responsible for the overall interaction between the user and the application. It presents options and information in an intuitive manner, guiding users through the features of the guide interaction tool. The UIM 210 communicates with the Data Storage Manager 214 to retrieve stored data and display it in an organized manner. It also works with the Speech-to-Text Manager 212 to facilitate voice commands, ensuring a seamless user experience.

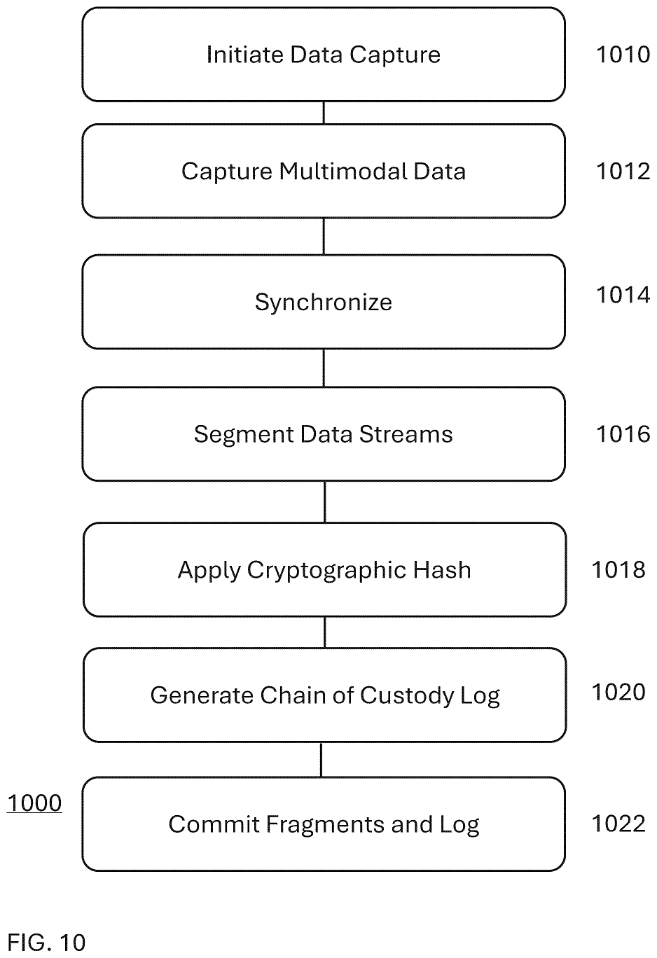

FIG. 10 illustrates a flowchart depicting a computer-implemented method 1000 for preserving forensic integrity of multimodal evidence captured during user interactions. The method 1000 may be executed by the processor 110 of the user computing device 201 in cooperation with the processor 410 of the system server 200. The flowchart employs traditional flowchart conventions, wherein rectangular process boxes represent operational steps and directional arrows indicate the flow of control through the method.

The method 1000 may begin at step 1010, which represents initiating a data capture session in response to a user activation event. The user activation event may comprise at least one of manual activation via the user interface manager 210, voice-activated wake-word detection via the speech-to-text manager 212, or contextual activation via detection of a predefined condition. Upon initiation, the processor 110 may generate a unique session identifier and may associate all subsequently captured data with that session identifier. The unique session identifier may comprise a universally unique identifier or a timestamp-based identifier. The data storage manager 214 may create a session record in the storage device 120 and may associate the session record with the unique session identifier.

The method 1000 may proceed to step 1012, which represents capturing, during the data capture session, a plurality of data streams. The plurality of data streams may comprise an audio stream from at least one microphone, a visual stream from at least one camera, and a positional stream from at least one global positioning system receiver. The processor 110 may activate the microphone 302 to capture audio data, the camera 301 to capture visual data, and the global positioning system receiver to capture positional data comprising geographic coordinates and timestamps. In embodiments corresponding to dependent claim 8, the plurality of data streams may be captured from a plurality of devices comprising at least two of a mobile device, a dash-mounted camera, a wearable device, and an internet-of-things sensor. The device integration control module 750 may transmit activation commands to the plurality of devices via the network manager 216, causing those devices to initiate concurrent multimodal data capture. Each device may transmit its captured data streams to the system server 200 via the network 199.

The method 1000 may proceed to step 1014, which represents assigning, by a temporal alignment module, synchronized timestamps to data segments from each of the plurality of data streams using a centralized time-stamping authority. The temporal alignment module may be implemented as a software component executing on the processor 410 of the system server 200. The centralized time-stamping authority may provide a reference clock signal to which all captured data segments may be synchronized. In embodiments corresponding to dependent claim 9, the centralized time-stamping authority may synchronize timestamps using a Network Time Protocol server accessible via the network 199. The temporal alignment module may receive data segments from the plurality of data streams, may determine the capture time of each data segment based on device-local timestamps, may apply clock offset corrections to account for discrepancies between device-local clocks and the centralized time-stamping authority, and may assign synchronized timestamps to each data segment. The synchronized timestamps may have millisecond precision or higher.

The method 1000 may proceed to step 1016, which represents segmenting the plurality of data streams into a plurality of media fragments. Each media fragment may be associated with one of the synchronized timestamps. The temporal alignment module may divide each data stream into discrete temporal segments based on a predefined fragment duration. In embodiments corresponding to dependent claim 10, each media fragment may have a duration between one second and sixty seconds. The fragment duration may be configurable by the user or may be dynamically adjusted based on available storage capacity or network bandwidth. Each media fragment may comprise a contiguous portion of audio data, visual data, or positional data captured during the fragment duration.

The method 1000 may proceed to step 1018, which represents applying a cryptographic hash function to each of the plurality of media fragments to generate a corresponding hash value. In embodiments corresponding to dependent claim 7, the cryptographic hash function may comprise a SHA-256 hash function. The processor 410 of the system server 200 may apply the cryptographic hash function to the binary content of each media fragment to generate a fixed-length hash value. The hash value may serve as a unique digital fingerprint of the media fragment, such that any modification to the media fragment may result in a different hash value. The hash values may be stored in association with their corresponding media fragments.

The method 1000 may proceed to step 1020, which represents generating a chain-of-custody log comprising the unique session identifier, the synchronized timestamps, and the hash values. The data storage manager 214 may create a structured log file comprising a plurality of log entries, each log entry corresponding to one media fragment. Each log entry may comprise the unique session identifier, the synchronized timestamp associated with the media fragment, the hash value generated for the media fragment, metadata identifying the source device that captured the media fragment, and metadata identifying the data stream type. The chain-of-custody log may provide a tamper-evident record of all media fragments captured during the data capture session.

The method 1000 may proceed to step 1022, which represents committing the plurality of media fragments and the chain-of-custody log to a write-once-read-many storage architecture to prevent post-capture modification. The data storage manager 214 may transmit the plurality of media fragments and the chain-of-custody log to the data retention systems 190 via the network manager 216 and the network 199. The data retention systems 190 may implement a write-once-read-many storage architecture, wherein data, once written, cannot be modified or deleted. The write-once-read-many storage architecture may be implemented using at least one of cloud-based immutable object storage, hardware-based write-once storage media, or blockchain-based distributed ledger technology. Upon successful commit, the data retention systems 190 may return a commit confirmation to the data storage manager 214, and the method 1000 may terminate or may return to step 1012 to continue capturing additional data streams during the active session.

The user interface manager 210 is configured to provide a user interface, e.g., a graphical user interface provided via a display, to allow user interaction with the guided interaction system user device 201. The user interface manager 210 is configured to receive input from any user input source, including but not limited to touchscreens, keyboards, mice, controllers, joysticks, voice control. The user interface manager 210 is configured to provide a user interface, such as a text based user interface, a graphical user interface, a voice based user interface, or any other suitable user interface. The user interface manager 210 is configured to use the network manager 216 to provide such user interface services through a display associated with the guided interaction system user device 201 or through a display (e.g., a vehicle display) to which the user device 201 is connected. The user interface manager 210 may be configured to provide different user interface services depending on a type of client device. For example, larger screen size may be provided with a user interface including a full suite of interface options, while a smartphone or tablet having a smaller screen size may be provided with a more limited user interface.

In embodiments, the user interface manager 210 may be configured to provide or cause the display of a graphical user interface (GUI), a voice based user interface, or a combination of graphical and voice based.

The data storage manager 214 is a software protocol operating on the guided interaction system user device 201. The Data Storage Manager (DSM) 214 handles all data storage needs, including the retention of user interactions, preferences, and recorded sessions. This module ensures that data is organized and easily retrievable. The DSM 214 works with the UIM 210 to display stored data and provides necessary information to the DTM 218 and NM 216 for decision-making and data transmission, respectively. The data storage manager 214 is configured to manage and organize the data collected during user interactions, ensuring that important information is easily accessible and securely stored. The d data recording module 214 may provide data to a user via the user interface manager 210, offering insights and recommendations based on previous interactions. Additionally, the data recording module 214 is further configured to provide access tools to users for retrieving, reviewing, and utilizing their stored data efficiently. It may also offer data retention capabilities to ensure that relevant information is maintained over time. The data recording module 214 is configured to access the one or more data retention systems 190 and/or the storage device 120 to store all data associated with the guided interaction system, ensuring comprehensive documentation of user experiences and interactions.

The speech-to-text manager 212 is a software protocol operating on the guided interaction system user device 201. The speech-to-Text Manager (STM) 212 converts spoken language into text, enabling hands-free operation of the guided interaction tool. This module recognizes commands and transcribes user interactions the in real time or near real time. User interactions refers to the words spoken both by the user and by another party with whom they are interacting. The STM 212 works closely with the UIM 210 to ensure that voice inputs are correctly interpreted and displayed. Additionally, it collaborates with the Decision Tree Manager 218 to provide contextually relevant options based on the user's spoken requests.

The decision tree manager 218 is a software protocol operating on the guided interaction system user device 201. The decision Tree Manager (DTM) 218 implements logic-based decision-making pathways that guide users through interactions. The decision tree manager 218 analyzes user input (e.g., in the form of speech translated to text, from the user or an interacting party) and selects appropriate responses or actions based on predefined algorithms. In some embodiments the predefined algorithms may include machine learning or artificial intelligence based algorithms. The DTM 218 receives input from the STM 212 and communicates with the UIM 210 to present users with relevant options. It also interfaces with the Network Manager 216 to send data back and forth between the user device and the server 200 for real-time updates.

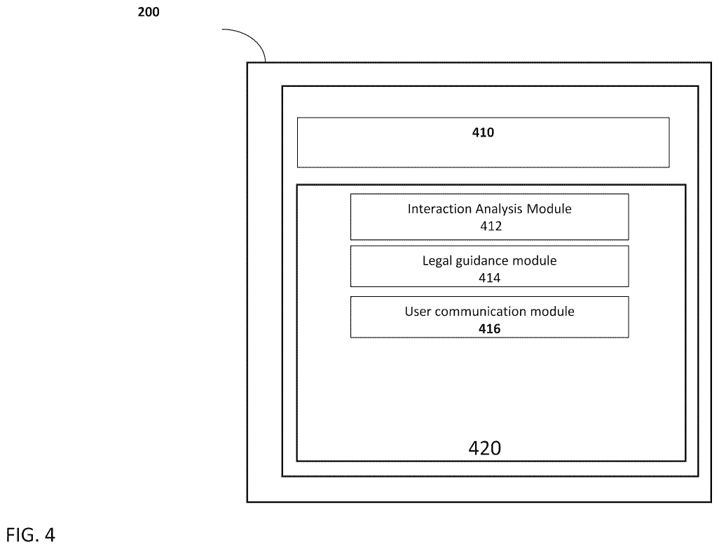

FIG. 4 illustrates the server 200 consistent with the guided interaction system described herein. The guided interaction system user device 201 includes one or more processors 410 (similar to processor 110), one or more storage device(s) 420 (similar to storage device 120), and/or other components. The server 200 may include at least an interaction analysis module 412, a legal guidance module 414, and a user communication module 416.

The interaction analysis module 412 is a software protocol operating on the guided interaction system server 200. The Interaction Analysis Module (IAM) 412 analyzes recorded interactions, including audio and, optionally, video, to identify trends, assess user behavior, and generate insights to improve future interactions. The IAM 412 receives data from the DSM 214 via the NM 216 and feeds back information to the DTM 218 to adjust decision-making pathways based on user patterns. In embodiments, the IAM 412 may employ machine learning or artificial intelligence based models to improve and/or adjust the decision making models employed by the DTM 218.

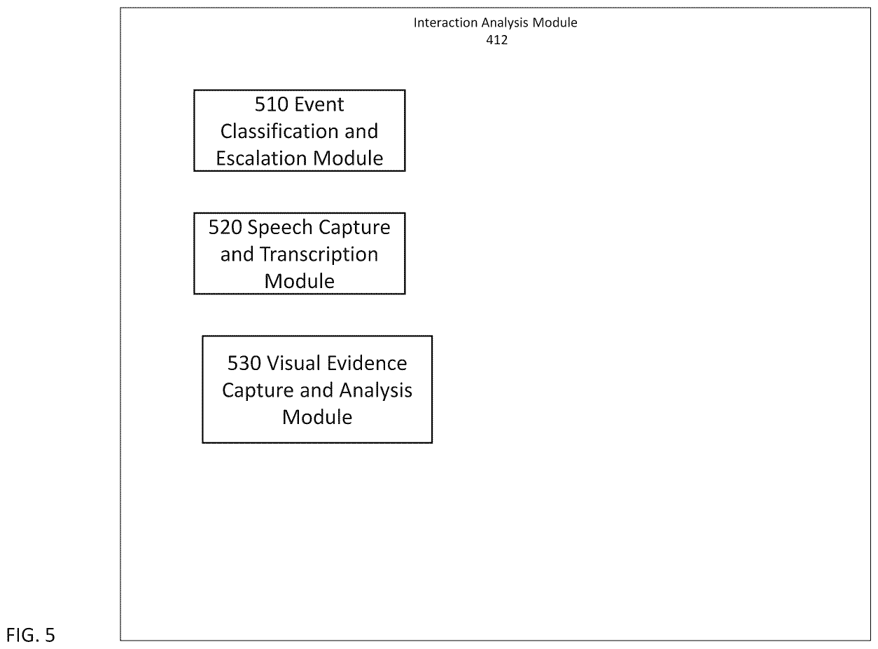

Referring now to FIG. 5, the interaction analysis module 412 may be described in greater detail. FIG. 5 illustrates an embodiment of the interaction analysis module 412 according to embodiments hereof. The interaction analysis module 412 may reside within the storage device 420 of the server 200 and may be executed by the processor 410. The interaction analysis module 412 may serve as the primary analytical subsystem of the server 200, receiving multimodal data from the user computing device 201 via the network manager 216 and the user communication module 416, and generating contextual assessments that may be used to produce prioritized guidance outputs.

As illustrated in FIG. 5, the interaction analysis module 412 may comprise an event classification and escalation module 510, a speech capture and transcription module 520, and a visual evidence capture and analysis module 530. Each of these submodules may operate in concert to transform raw multimodal data into a structured, probabilistic encounter representation suitable for downstream legal guidance generation by the legal guidance module 414.

The event classification and escalation module 510 may be a software protocol operating within the interaction analysis module 412. The event classification and escalation module 510 may receive the timestamped text transcript from the speech capture and transcription module 520, the structured visual event log from the visual evidence capture and analysis module 530, and positional data obtained via the global positioning system receiver of the user computing device 201. The event classification and escalation module 510 may fuse the text transcript, the entity labels, and the location attributes using a transformer-based architecture to generate a unified multimodal representation. The transformer-based architecture may comprise a BERT-based architecture or a GPT-based architecture or other suitable architecture. The event classification and escalation module 510 may apply the transformer-based architecture to the unified multimodal representation to generate a probabilistic encounter classification comprising at least one of a traffic stop classification, a detention classification, an investigation classification, and an arrest classification. Each classification may be associated with a confidence score. The event classification and escalation module 510 may select a classification from the probabilistic encounter classification based on the confidence score and may trigger, based on the selected classification, jurisdiction-specific legal guidance corresponding to the selected classification.

The event classification and escalation module 510 may further analyze acoustic features of the audio data, including elevated vocal intensity, command speech patterns, and shouting, to generate a real-time risk level score. The risk level score may be combined with the probabilistic encounter classification and forwarded to the legal guidance module 414 as part of a contextual assessment. Upon determining that the risk level score or the probabilistic encounter classification satisfies a predefined escalation threshold, the event classification and escalation module 510 may generate an escalation trigger event. The escalation trigger event may cause the user communication module 416 to initiate an encrypted communication channel with a designated attorney via a WebRTC connection, and may cause the user computing device 201 to transmit a structured incident summary to the designated attorney, the incident summary comprising at least one of encounter type, geographic location, timestamp, and rights assertions made.

The speech capture and transcription module 520 may be a software protocol operating within the interaction analysis module 412. The speech capture and transcription module 520 may receive audio data captured by the microphone 302 of the user computing device 201 and transmitted to the server 200 via the network 199. The speech capture and transcription module 520 may apply one or more automatic speech recognition models to the received audio data to generate a timestamped text transcript. The speech capture and transcription module 520 may further apply speaker diarization techniques to differentiate between speech produced by the user and speech produced by one or more other parties to the interaction, such as a law enforcement officer. The resulting transcript may be associated with a unique session identifier and may be forwarded to the event classification and escalation module 510 for further analysis. The speech capture and transcription module 520 may further monitor the generated transcript for predefined legally significant keywords and phrases, including at least one of “search,” “arrest,” “consent,” “lawyer,” and “warrant,” and may generate a keyword detection event upon identifying such terms within the transcript. A keyword detection event may trigger a corresponding legal rule lookup within a pruned legal dataset maintained by the legal guidance module 414.

The visual evidence capture and analysis module 530 may be a software protocol operating within the interaction analysis module 412. The visual evidence capture and analysis module 530 may receive visual data captured by the camera 301 of the user computing device 201 and transmitted to the server 200 via the network 199. The visual evidence capture and analysis module 530 may apply one or more object detection models to the received visual data to identify objects and entities of interest within captured image frames. Such objects and entities may include, but may not be limited to, law enforcement badges, law enforcement uniforms, law enforcement vehicles, body-worn cameras, and weapons. The visual evidence capture and analysis module 530 may further apply an optical character recognition component to extract text from identified visual entities, the extracted text comprising at least one of badge numbers, department names, and unit identifiers. The visual evidence capture and analysis module 530 may generate a structured visual event log comprising identified entity labels, extracted text, and associated timestamps, and may forward the visual event log to the event classification and escalation module 510.

The interaction analysis module 412 may further apply a temporal alignment operation to synchronize the outputs of the speech capture and transcription module 520 and the visual evidence capture and analysis module 530 using timestamps assigned by a centralized time-stamping authority. The temporal alignment operation may correlate audio transcript segments, visual event detections, and positional data points into a unified, chronologically ordered incident timeline associated with the session identifier. The unified incident timeline may be stored in the storage device 420 and may be made available to the legal guidance module 414 for legal weighting and guidance generation.

The interaction analysis module 412 may further receive user-specific attributes from a secure user attribute vault accessible via the data retention systems 190. The user-specific attributes may comprise at least one of demographic data, firearm permit data, vehicle registration data, medical condition data, and prior interaction history data. The interaction analysis module 412 may inject the user-specific attributes into the contextual assessment prior to forwarding the contextual assessment to the legal guidance module 414, thereby enabling the legal weighting algorithm applied by the legal guidance module 414 to generate prioritized guidance that accounts for the user's unique legal context and personal circumstances.

In embodiments, the interaction analysis module 412 may also query the geospatial intelligence ledger stored in the data retention systems 190 using the geographic coordinates obtained from the positional data. The interaction analysis module 412 may retrieve location-specific incident metadata associated with the geographic coordinates, the location-specific incident metadata comprising at least one of incident type, incident timestamp, and incident sentiment tag. The retrieved location-specific incident metadata may be incorporated into the contextual assessment and may be applied by the legal guidance module 414 as part of the legal weighting algorithm to generate prioritized guidance tailored to the specific geographic and legal context of the user's encounter.

The legal guidance module 414 is a software protocol operating on the guided interaction system server 200. The Legal Guidance Module (LGM) 414 provides real-time legal advice and information based on the context of user interactions. In embodiments, such legal advice and information may include rights and best practices during encounters with law enforcement or in any other user interaction that may have legal implications, e.g., contract negotiations, car sales, etc. The LGM 414 works with the DTM 218 to ensure users receive timely and relevant legal information tailored to their specific circumstances, thereby enhancing the guidance provided by the guided user interaction system.

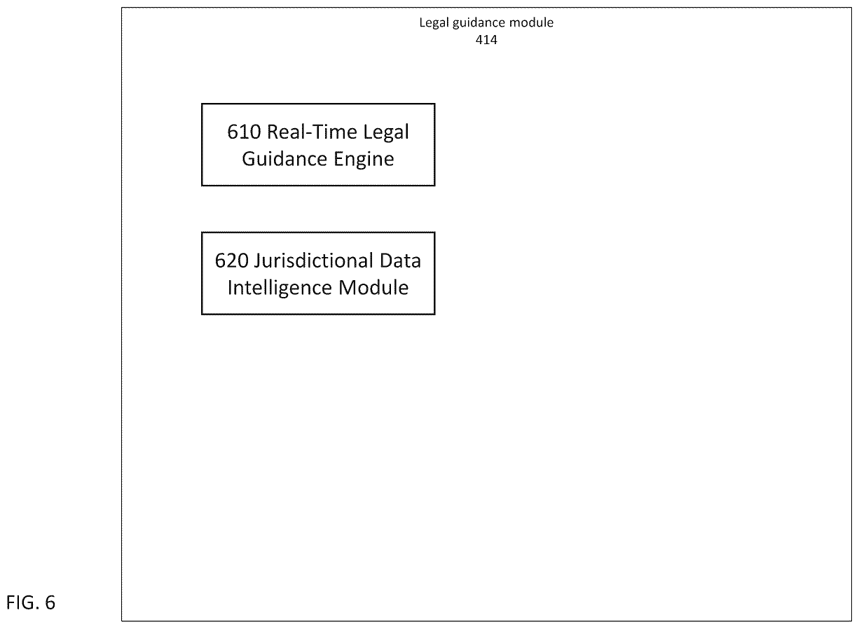

Referring now to FIG. 6, the legal guidance module 414 may be described in greater detail. FIG. 6 illustrates an embodiment of the legal guidance module 414 according to embodiments hereof. The legal guidance module 414 may reside within the storage device 420 of the server 200 and may be executed by the processor 410. The legal guidance module 414 may serve as the primary jurisdiction-aware guidance generation subsystem of the server 200, receiving contextual assessments from the interaction analysis module 412 and generating prioritized guidance outputs that may be transmitted to the user computing device 201 via the user communication module 416.

As illustrated in FIG. 6, the legal guidance module 414 may comprise a real-time legal guidance engine 610 and a jurisdictional data intelligence module 620. Each of these submodules may operate in concert to transform contextual assessments received from the interaction analysis module 412 into jurisdiction-specific, prioritized guidance outputs suitable for presentation to the user via the user interface manager 210.

The real-time legal guidance engine 610 may be a software protocol operating within the legal guidance module 414. The real-time legal guidance engine 610 may receive the pruned legal dataset from the jurisdictional data intelligence module 620, the contextual assessment from the interaction analysis module 412, and location-specific incident metadata retrieved from the geospatial intelligence ledger stored in the data retention systems 190. The real-time legal guidance engine 610 may further retrieve user-specific attributes from a secure user attribute vault accessible via the data retention systems 190. The user-specific attributes may comprise at least one of demographic data, firearm permit data, vehicle registration data, medical condition data, and prior interaction history data.

The real-time legal guidance engine 610 may apply a legal weighting algorithm to the contextual assessment, the location-specific incident metadata, the pruned legal dataset, and the user-specific attributes to generate prioritized guidance. The legal weighting algorithm may assign a first weight to the contextual assessment, a second weight to the location-specific incident metadata, and a third weight to the pruned legal dataset. The legal weighting algorithm may compute a weighted score for each of a plurality of candidate guidance options based on the first weight, the second weight, and the third weight. The candidate guidance option associated with the highest weighted score may be selected as the prioritized guidance output.

The real-time legal guidance engine 610 may further comprise a rights assertion module configured to select applicable pre-approved rights assertion scripts from a rights script library based on detected trigger conditions and jurisdictional requirements. The rights assertion scripts may comprise at least one of “I do not consent to searches,” “I wish to remain silent,” “I want to speak to a lawyer,” and “Am I free to leave.” Upon detecting a keyword detection event generated by the speech capture and transcription module 520, the real-time legal guidance engine 610 may retrieve the corresponding legal rule from the pruned legal dataset and may incorporate the retrieved legal rule into the prioritized guidance output. The real-time legal guidance engine 610 may further apply an officer interaction compliance checker to evaluate detected law enforcement statements against jurisdiction-specific compliance rules stored in the pruned legal dataset, and may generate a compliance alert upon identifying conditions that may indicate a potential rights violation.

The real-time legal guidance engine 610 may further execute a dynamic interrogative module to generate a plurality of diagnostic prompts based on situational context derived from the contextual assessment. The diagnostic prompts may be transmitted to the user computing device 201 via the user communication module 416 and may be presented to the user via the user interface manager 210. User responses to the diagnostic prompts may be received by the real-time legal guidance engine 610 and may be injected as situational attributes into the legal weighting algorithm to refine the prioritized guidance output. The situational attributes may comprise at least one of occupancy density data, tactical safety status data, and sensitive asset presence data.

The real-time legal guidance engine 610 may assemble a final guidance output comprising recommended actions, rights assertion scripts, and compliance alerts. The final guidance output may be transmitted to the user computing device 201 via the user communication module 416 for presentation to the user via the user interface manager 210. The user interface manager 210 may render the final guidance output as textual guidance on the display of the user computing device 201, as synthesized speech delivered through the audio output device of the user computing device 201, or as a combination of both. The final guidance output may further be rendered in an iconographic format configured to enable rapid comprehension under conditions of cognitive stress.

In embodiments, the real-time legal guidance engine 610 may further apply a transformer-based neural network to the probabilistic encounter classification received from the event classification and escalation module 510 to generate a prioritized action recommendation. The transformer-based neural network may comprise a BERT-based architecture or a GPT-based architecture or other suitable architecture. The prioritized action recommendation may be incorporated into the final guidance output and may be transmitted to the user computing device 201. The legal guidance module 414 may operate concurrently with the interaction analysis module 412 such that the final guidance output may be updated continuously as new multimodal data may be received from the user computing device 201 during an active session.

The jurisdictional data intelligence module 620 may be a software protocol operating within the legal guidance module 414. The jurisdictional data intelligence module 620 may receive positional data comprising geographic coordinates from the interaction analysis module 412 and may apply those coordinates to query a legal database stored in the data retention systems 190. The legal database may comprise a plurality of jurisdiction-specific legal rules indexed by geographic region. The jurisdictional data intelligence module 620 may identify a hierarchical jurisdiction structure corresponding to the geographic coordinates. The hierarchical jurisdiction structure may comprise at least one of a federal jurisdiction, a state jurisdiction, and a local jurisdiction. The jurisdictional data intelligence module 620 may retain legal rules associated with each level of the hierarchical jurisdiction structure and may discard statutes, regulations, and procedural rules that may be irrelevant to the user's verified geographic coordinates, demographic attributes, and encounter type classification received from the interaction analysis module 412. The resulting pruned legal dataset may comprise only those jurisdiction-specific legal rules applicable to the jurisdiction corresponding to the geographic coordinates. The pruned legal dataset may be forwarded to the real-time legal guidance engine 610 for application to the contextual assessment.

The jurisdictional data intelligence module 620 may further maintain a dynamic repository of codified statutes, constitutional provisions, local ordinances, speed limit data, school zone designations, border enforcement zone parameters, and firearms disclosure requirements, each indexed by geographic coordinate, jurisdiction identifier, and effective date. The jurisdictional data intelligence module 620 may apply effective date filtering to the legal database to ensure that only currently operative legal rules may be retained within the pruned legal dataset. The jurisdictional data intelligence module 620 may further receive geofenced jurisdictional trigger events generated by the interaction analysis module 412 upon detection of entry into specialized legal zones, including at least extended border enforcement zones and school zones, and may dynamically adjust the pruned legal dataset to incorporate the applicable federal or municipal legal rules associated with those zones.

The user communications module 416 is a software protocol operating on the guided interaction system server 200. The user communication module 416 is similar to the network manager 216 and is configured to facilitate all necessary communications between the guided interaction system server 200 and one or more guided interaction system user devices 201.

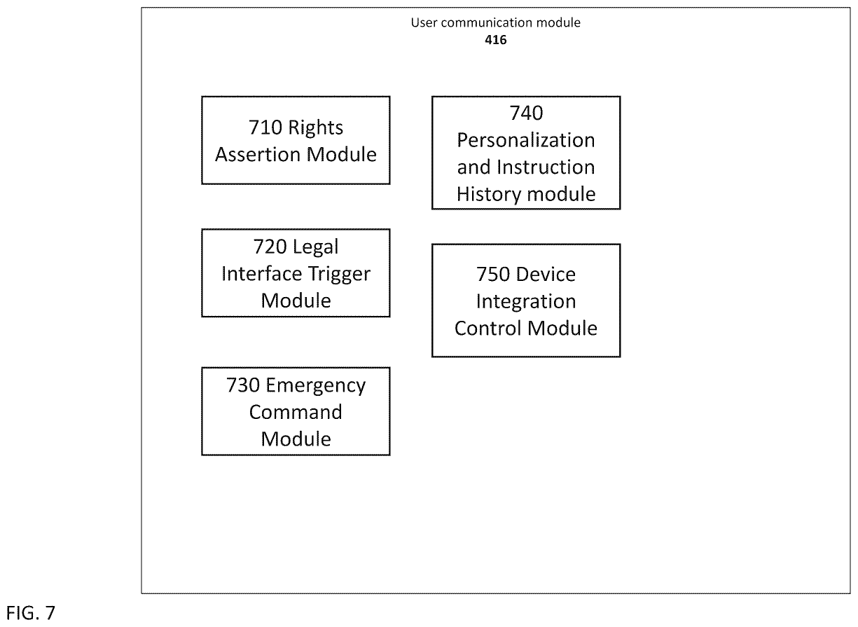

Referring now to FIG. 7, the user communication module 416 may be described in greater detail. FIG. 7 illustrates an embodiment of the user communication module 416 according to embodiments hereof. The user communication module 416 may reside within the storage device 420 of the server 200 and may be executed by the processor 410. The user communication module 416 may serve as the primary communication and escalation subsystem of the server 200, facilitating all necessary communications between the server 200 and the user computing device 201, and coordinating the delivery of guidance outputs, rights assertion scripts, attorney communications, and device control instructions generated by the interaction analysis module 412 and the legal guidance module 414.

As illustrated in FIG. 7, the user communication module 416 may comprise a rights assertion module 710, a legal interface trigger module 720, an emergency command module 730, a personalization and instruction history module 740, and a device integration control module 750. Each of these submodules may operate in concert to transform prioritized guidance outputs received from the legal guidance module 414 into user-consumable communications delivered to the user computing device 201 via the network 199.

The rights assertion module 710 may be a software protocol operating within the user communication module 416. The rights assertion module 710 may receive prioritized guidance outputs from the real-time legal guidance engine 610 and may select applicable pre-approved rights assertion scripts from a rights script library based on detected trigger conditions and jurisdictional requirements identified by the legal guidance module 414. The rights assertion scripts may comprise at least one of “I do not consent to searches,” “I wish to remain silent,” “I want to speak to a lawyer,” and “Am I free to leave.” The rights assertion module 710 may transmit the selected rights assertion scripts to the user computing device 201 for presentation via the user interface manager 210. The user interface manager 210 may render the rights assertion scripts as textual output on the display of the user computing device 201, as synthesized speech delivered through the audio output device of the user computing device 201, or as a combination of both. The rights assertion module 710 may further apply an officer interaction compliance checker to evaluate detected law enforcement statements against jurisdiction-specific compliance rules retained within the pruned legal dataset maintained by the legal guidance module 414, and may generate a compliance alert upon identifying conditions that may indicate a potential rights violation. The compliance alert may be transmitted to the user computing device 201 and may be rendered in an iconographic format configured to enable rapid comprehension under conditions of cognitive stress.

The legal interface trigger module 720 may be a software protocol operating within the user communication module 416. The legal interface trigger module 720 may receive escalation trigger events generated by the event classification and escalation module 510 and may initiate an encrypted communication channel between the user computing device 201 and a designated attorney. The encrypted communication channel may comprise a WebRTC connection brokered by a WebRTC communications server accessible via the network 199. Upon establishing the encrypted communication channel, the legal interface trigger module 720 may transmit a structured incident summary to the designated attorney via a secure attorney interface. The structured incident summary may comprise at least one of encounter type, geographic location, timestamp, and rights assertions made during the active session. The legal interface trigger module 720 may further support real-time audio and video communication between the user and the designated attorney through the encrypted communication channel, enabling the designated attorney to deliver context-aware legal guidance directly to the user during the active session.

The emergency command module 730 may be a software protocol operating within the user communication module 416. The emergency command module 730 may monitor audio data received from the user computing device 201 for predefined activation phrases, including at least “Just-Us Emergency” and “Police stop mode,” via a wake-word detection module operating on the user computing device 201. Upon detecting a predefined activation phrase, the emergency command module 730 may transmit an activation command to the user computing device 201 causing the camera 301 and the microphone 302 to initiate multimodal data capture. The emergency command module 730 may further transmit a cloud backup synchronization command to the user computing device 201, causing all locally buffered multimodal data to be immediately transmitted to the data retention systems 190 for archival within the write-once-read-many storage architecture. The emergency command module 730 may additionally transmit notifications to designated emergency contacts of the user, the notifications comprising at least the user's current geographic coordinates and a secure link to the active session record.

The personalization and instruction history module 740 may be a software protocol operating within the user communication module 416. The personalization and instruction history module 740 may retrieve user-specific attributes from a secure user attribute vault accessible via the data retention systems 190. The user-specific attributes may comprise at least one of demographic data, firearm permit data, vehicle registration data, medical condition data, and prior interaction history data. The personalization and instruction history module 740 may apply the user-specific attributes to tailor the delivery format and content of guidance outputs transmitted to the user computing device 201, thereby accounting for the user's unique legal context and personal circumstances. The personalization and instruction history module 740 may further maintain a record of guidance outputs delivered during prior interaction sessions and may apply that record to refine the prioritization of guidance outputs in subsequent sessions. User responses to diagnostic prompts generated by the dynamic interrogative module of the real-time legal guidance engine 610 may be received by the personalization and instruction history module 740 and may be stored as updated situational attributes within the secure user attribute vault.

The device integration control module 750 may be a software protocol operating within the user communication module 416. The device integration control module 750 may manage the discovery, pairing, activation, and data stream aggregation of one or more external sensor systems communicatively coupled to the user computing device 201. Such external sensor systems may include, but may not be limited to, vehicle-mounted dashcams, smart glasses, wearable cameras, IoT automotive sensors, and drone-mounted cameras. The device integration control module 750 may transmit activation commands to registered external sensor systems via the network manager 216 of the user computing device 201, causing those devices to initiate multimodal data capture upon session activation. The device integration control module 750 may further receive data streams from connected external sensor systems and may route those streams to the interaction analysis module 412 for incorporation into the unified incident timeline maintained by the temporal alignment operation. Upon detection of network loss by the network manager 216, the device integration control module 750 may transmit a local caching command to the user computing device 201, causing all data streams from connected external sensor systems to be written to the local incident context buffer pending re-synchronization upon connectivity restoration.

In embodiments, the user communication module 416 may operate concurrently with the interaction analysis module 412 and the legal guidance module 414 such that guidance outputs, rights assertion scripts, compliance alerts, and device control instructions may be updated continuously as new multimodal data may be received from the user computing device 201 during an active session. The user communication module 416 may further transmit a post-session summary to the user computing device 201 upon session termination, the post-session summary comprising at least one of a timestamped transcript of the interaction, an AI advisory log, and a secure link to the forensic evidence record stored in the data retention systems 190. The user communication module 416 may additionally present the user with options to share the forensic evidence record with designated attorneys, civil rights organizations, or emergency contacts via encrypted export links generated by the data storage manager 214.

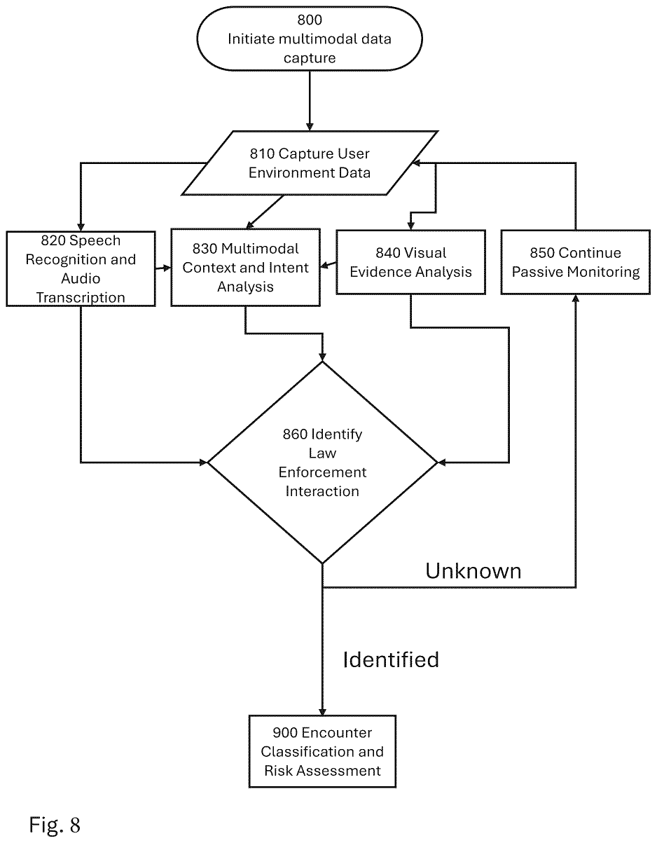

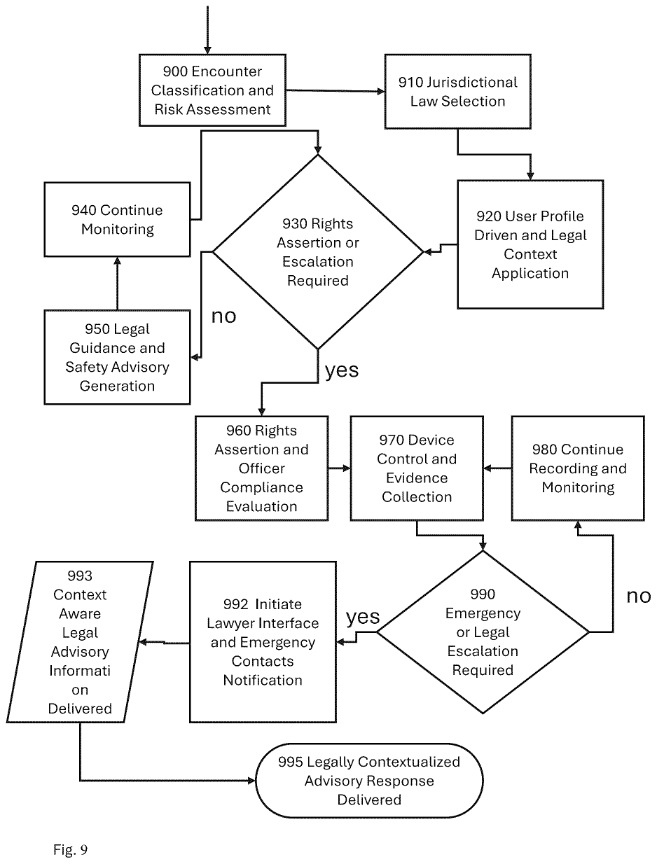

FIG. 8 and FIG. 9 together illustrate a two-part flowchart depicting the complete operational workflow of the guided interaction system from initial multimodal data capture through final legal advisory delivery. The flowchart employs traditional flowchart conventions, wherein rectangular process boxes represent operational steps executed by system components, diamond-shaped decision boxes represent conditional branching points, and directional arrows indicate the flow of control and data through the system. Element 900 serves as the connecting point between FIG. 8 and FIG. 9, representing the transition from data capture and interaction detection to encounter classification and legal response generation.

Referring first to FIG. 8, the workflow may begin at element 800, which represents the initiation of multimodal data capture. The initiation may be triggered by a user activation event, which may comprise at least one of manual activation via the user interface manager 210, voice-activated wake-word detection via the speech-to-text manager 212, or contextual activation via detection of a predefined condition such as sudden deceleration detected by an accelerometer of the user computing device 201. Upon initiation, the processor 110 of the user computing device 201 may generate a unique session identifier and may associate all subsequently captured data with that session identifier.

The workflow may proceed to element 810, which represents the capture of user environment data. The user computing device 201 may activate the camera 301 to capture visual data, the microphone 302 to capture audio data, and the global positioning system receiver to capture positional data comprising geographic coordinates and timestamps. The data storage manager 214 may buffer the captured multimodal data in the storage device 120 and may transmit the data to the system server 200 via the network manager 216 and the network 199. In embodiments, the device integration control module 750 may further transmit activation commands to one or more external sensor systems, including at least vehicle-mounted dashcams, smart glasses, wearable cameras, and IoT automotive sensors, causing those devices to initiate concurrent multimodal data capture.

The workflow may proceed to element 820, which represents speech recognition and audio transcription. The speech capture and transcription module 520 of the interaction analysis module 412 may receive the audio data from the user computing device 201 and may apply one or more automatic speech recognition models to generate a timestamped text transcript. The speech capture and transcription module 520 may further apply speaker diarization techniques to differentiate between speech produced by the user and speech produced by one or more other parties to the interaction. The resulting transcript may be associated with the session identifier and may be forwarded to the event classification and escalation module 510.

The workflow may proceed to element 830, which represents multimodal context and intent analysis. The event classification and escalation module 510 may receive the timestamped text transcript from the speech capture and transcription module 520, positional data from the user computing device 201, and structured visual event logs from the visual evidence capture and analysis module 530. The event classification and escalation module 510 may fuse the text transcript, entity labels extracted from visual data, and location attributes using a transformer-based architecture to generate a unified multimodal representation.

The workflow may proceed to element 840, which represents visual evidence analysis. The visual evidence capture and analysis module 530 may receive visual data captured by the camera 301 and may apply one or more object detection models to identify objects and entities of interest within captured image frames. Such objects and entities may include at least law enforcement badges, law enforcement uniforms, law enforcement vehicles, body-worn cameras, and weapons. The visual evidence capture and analysis module 530 may further apply an optical character recognition component to extract text from identified visual entities, the extracted text comprising at least one of badge numbers, department names, and unit identifiers. The visual evidence capture and analysis module 530 may generate a structured visual event log comprising identified entity labels, extracted text, and associated timestamps.

The workflow may proceed to element 850, which represents continue passive monitoring. During passive monitoring, the user computing device 201 may continue to capture multimodal data and may transmit that data to the system server 200 for ongoing analysis by the interaction analysis module 412. The speech capture and transcription module 520 may continue to monitor the generated transcript for predefined legally significant keywords and phrases, including at least one of “search,” “arrest,” “consent,” “lawyer,” and “warrant.” Upon detecting such keywords, the speech capture and transcription module 520 may generate a keyword detection event and may forward that event to the event classification and escalation module 510.

The workflow may proceed to element 860, which represents a decision point for identifying a law enforcement interaction. The event classification and escalation module 510 may analyze the unified multimodal representation generated at element 830 to determine whether the captured data indicates the presence of a law enforcement interaction. The determination may be based on at least one of detection of law enforcement uniforms or badges via the visual evidence capture and analysis module 530, detection of legally significant keywords via the speech capture and transcription module 520, or detection of acoustic features indicative of command speech patterns or elevated vocal intensity. If the event classification and escalation module 510 determines that a law enforcement interaction has not been identified, the workflow may return to element 850 to continue passive monitoring. If the event classification and escalation module 510 determines that a law enforcement interaction has been identified, the workflow may proceed to element 900.

Element 900 represents encounter classification and risk assessment, which serves as the connecting point between FIG. 8 and FIG. 9. The event classification and escalation module 510 may apply the transformer-based architecture to the unified multimodal representation to generate a probabilistic encounter classification comprising at least one of a traffic stop classification, a detention classification, an investigation classification, and an arrest classification. Each classification may be associated with a confidence score. The event classification and escalation module 510 may select a classification from the probabilistic encounter classification based on the confidence score. The event classification and escalation module 510 may further analyze acoustic features of the audio data to generate a real-time risk level score. The risk level score may be combined with the probabilistic encounter classification to form a contextual assessment, which may be forwarded to the legal guidance module 414.

Referring now to FIG. 9, the workflow may continue from element 900 to element 910, which represents jurisdictional law selection. The jurisdictional data intelligence module 620 of the legal guidance module 414 may receive positional data comprising geographic coordinates from the interaction analysis module 412 and may apply those coordinates to query a legal database stored in the data retention systems 190. The jurisdictional data intelligence module 620 may identify a hierarchical jurisdiction structure corresponding to the geographic coordinates, the hierarchical jurisdiction structure comprising at least one of a federal jurisdiction, a state jurisdiction, and a local jurisdiction. The jurisdictional data intelligence module 620 may retain legal rules associated with each level of the hierarchical jurisdiction structure and may discard statutes, regulations, and procedural rules that may be irrelevant to the user's verified geographic coordinates, demographic attributes, and encounter type classification. The resulting pruned legal dataset may comprise only those jurisdiction-specific legal rules applicable to the jurisdiction corresponding to the geographic coordinates.

The workflow may proceed to element 920, which represents user profile driven and legal context application. The real-time legal guidance engine 610 of the legal guidance module 414 may retrieve user-specific attributes from a secure user attribute vault accessible via the data retention systems 190. The user-specific attributes may comprise at least one of demographic data, firearm permit data, vehicle registration data, medical condition data, and prior interaction history data. The real-time legal guidance engine 610 may further query the geospatial intelligence ledger stored in the data retention systems 190 using the geographic coordinates to retrieve location-specific incident metadata, the location-specific incident metadata comprising at least one of incident type, incident timestamp, and incident sentiment tag. The real-time legal guidance engine 610 may apply a legal weighting algorithm to the contextual assessment received from the event classification and escalation module 510, the location-specific incident metadata, the pruned legal dataset, and the user-specific attributes to generate prioritized guidance.

In embodiments, the predictive logic engine may be further configured to monitor the geospatial intelligence ledger for high-density incident indicators within a geographic area. The predictive logic engine may periodically query the geospatial intelligence ledger to identify geographic areas in which the number of incidents exceeds a predefined threshold within a specified time period. The predefined threshold may comprise a minimum number of incidents per unit area per unit time, such as ten incidents per square kilometer per month. The specified time period may comprise a rolling time window, such as the most recent thirty days, sixty days, or ninety days.

When the predictive logic engine determines that a number of incidents within a geographic area exceeds the predefined threshold, the predictive logic engine may generate a heuristic trigger associated with that geographic area. The heuristic trigger may comprise a data structure stored in the data retention systems 190 and associated with the geographic coordinates defining the geographic area. The heuristic trigger may further comprise metadata identifying the incident types that contributed to exceeding the threshold, such as search requests, detention events, or rights violations.

Upon generating a heuristic trigger, the predictive logic engine may adjust the legal weighting algorithm to prioritize guidance corresponding to the identified incident types when a user computing device 201 reports geographic coordinates within the geographic area associated with the heuristic trigger. For example, if a heuristic trigger indicates a high frequency of unlawful search requests in a particular geographic area, the predictive logic engine may increase the weighting assigned to rights assertion scripts related to search consent when generating prioritized guidance for users entering that geographic area. The heuristic trigger may thereby prime the AI responses to proactively address location-specific legal risks based on community-driven incident patterns.

In embodiments, the system may further implement geofenced jurisdictional triggers that detect entry into specialized jurisdictional zones. Such specialized jurisdictional zones may comprise extended border enforcement zones, school zones, speed trap corridors, or other areas in which legal standards or enforcement practices may differ from surrounding areas. The geofenced jurisdictional triggers may be defined by geographic boundaries stored in the geospatial intelligence ledger or the legal database. When the positional data received from a user computing device 201 indicates that the user has entered a specialized jurisdictional zone, the predictive logic engine may dynamically adjust legal weighting or guidance priorities to reflect the jurisdiction-specific legal standards applicable within that zone.

The workflow may proceed to element 930, which represents a decision point for determining whether rights assertion or escalation is required. The real-time legal guidance engine 610 may evaluate the contextual assessment, the pruned legal dataset, and the user-specific attributes to determine whether conditions exist that may trigger rights assertion or legal escalation. Such conditions may include at least detection of legally significant keywords via the speech capture and transcription module 520, detection of a risk level score exceeding a predefined escalation threshold, or detection of a compliance alert generated by an officer interaction compliance checker. If the real-time legal guidance engine 610 determines that rights assertion or escalation is not required, the workflow may proceed to element 940. If the real-time legal guidance engine 610 determines that rights assertion or escalation is required, the workflow may proceed to element 950.

Element 940 represents continue monitoring. The system may continue to capture multimodal data and may continue to analyze that data via the interaction analysis module 412 and the legal guidance module 414. The workflow may return to element 920 to apply updated contextual assessments and legal weighting as new data becomes available during the active session.

Element 950 represents legal guidance and safety advisory generation. The real-time legal guidance engine 610 may generate a final guidance output comprising recommended actions, rights assertion scripts, and compliance alerts. The rights assertion scripts may comprise at least one of “I do not consent to searches,” “I wish to remain silent,” “I want to speak to a lawyer,” and “Am I free to leave.” The real-time legal guidance engine 610 may further execute a dynamic interrogative module to generate a plurality of diagnostic prompts based on situational context derived from the contextual assessment. The diagnostic prompts may be transmitted to the user computing device 201 via the user communication module 416 and may be presented to the user via the user interface manager 210. User responses to the diagnostic prompts may be received by the real-time legal guidance engine 610 and may be injected as situational attributes into the legal weighting algorithm to refine the prioritized guidance output.

The workflow may proceed to element 960, which represents rights assertion and officer compliance evaluation. The rights assertion module 710 of the user communication module 416 may transmit the selected rights assertion scripts to the user computing device 201 for presentation via the user interface manager 210. The user interface manager 210 may render the rights assertion scripts as textual output on the display of the user computing device 201, as synthesized speech delivered through the audio output device of the user computing device 201, or as a combination of both. The rights assertion module 710 may further apply an officer interaction compliance checker to evaluate detected law enforcement statements against jurisdiction-specific compliance rules retained within the pruned legal dataset, and may generate a compliance alert upon identifying conditions that may indicate a potential rights violation.

The workflow may proceed to element 970, which represents device control and evidence collection. The device integration control module 750 of the user communication module 416 may transmit activation commands to registered external sensor systems via the network manager 216, causing those devices to continue multimodal data capture. The data storage manager 214 may buffer all captured multimodal data in the storage device 120 and may transmit the data to the data retention systems 190 for archival. In embodiments, the system may apply a cryptographic hash function to each media fragment and may commit the cryptographically signed fragments to a write-once-read-many storage architecture to preserve evidentiary integrity.

The workflow may proceed to element 980, which represents continue recording and monitoring. The system may continue to capture multimodal data and may continue to analyze that data via the interaction analysis module 412 and the legal guidance module 414. The workflow may proceed to element 990.

Element 990 represents a decision point for determining whether emergency or legal escalation is required. The event classification and escalation module 510 may evaluate the risk level score and the probabilistic encounter classification to determine whether conditions exist that may trigger emergency escalation. Such conditions may include at least detection of a risk level score exceeding a predefined emergency escalation threshold, detection of a predefined activation phrase such as “Just-Us Emergency” or “I need a lawyer,” or detection of acoustic features indicative of physical confrontation or distress. If the event classification and escalation module 510 determines that emergency or legal escalation is not required, the workflow may return to element 980 to continue recording and monitoring. If the event classification and escalation module 510 determines that emergency or legal escalation is required, the workflow may proceed to element 992.

Element 992 represents initiate lawyer interface and emergency contacts notification. The legal interface trigger module 720 of the user communication module 416 may initiate an encrypted communication channel between the user computing device 201 and a designated attorney. The encrypted communication channel may comprise a WebRTC connection brokered by a WebRTC communications server accessible via the network 199. The emergency command module 730 may further transmit notifications to designated emergency contacts of the user, the notifications comprising at least the user's current geographic coordinates and a secure link to the active session record.

The workflow may proceed to element 993, which represents context aware legal advisory information delivered. The legal interface trigger module 720 may transmit a structured incident summary to the designated attorney via a secure attorney interface. The structured incident summary may comprise at least one of encounter type, geographic location, timestamp, and rights assertions made during the active session. The legal interface trigger module 720 may further support real-time audio and video communication between the user and the designated attorney through the encrypted communication channel.

The workflow may proceed to element 995, which represents legally contextualized advisory response delivered. The designated attorney may deliver context-aware legal guidance directly to the user during the active session via the encrypted communication channel. The user interface manager 210 may render the attorney's guidance as audio output via the audio output device of the user computing device 201 and may optionally render video output via the display of the user computing device 201. Upon completion of the attorney communication, the workflow may return to element 980 to continue recording and monitoring until the user terminates the session or the system detects a session end condition.

The two-part flowchart illustrated in FIG. 8 and FIG. 9 demonstrates the complete operational workflow of the guided interaction system, from initial multimodal data capture through final legal advisory delivery, and illustrates the integration of the user computing device 201, the system server 200, the interaction analysis module 412, the legal guidance module 414, and the user communication module 416 to provide real-time, jurisdiction-aware legal guidance and forensic evidence preservation during high-stress user interactions.

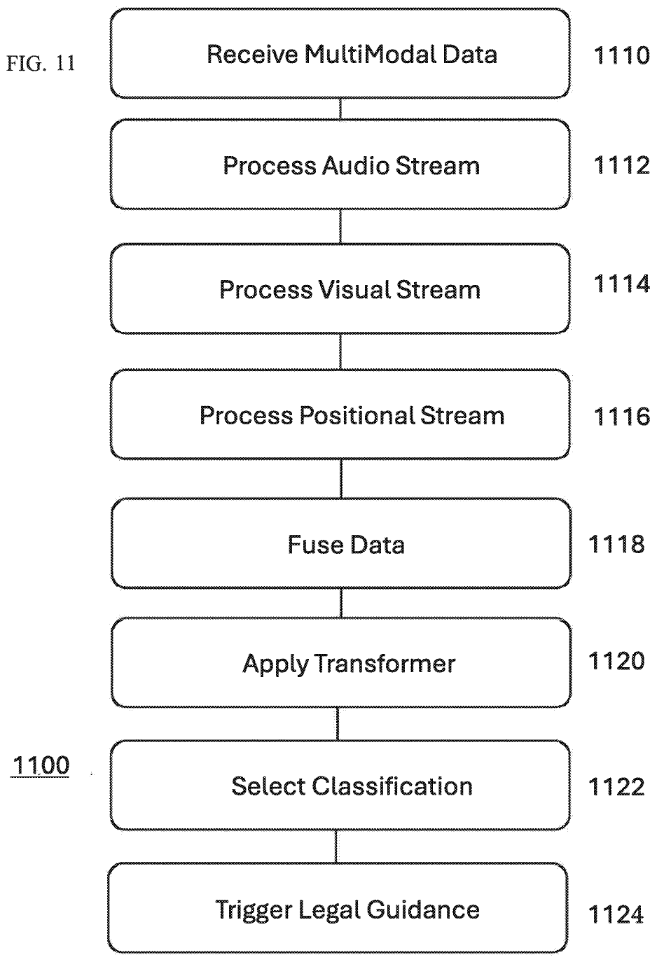

FIG. 11 illustrates a flowchart depicting a computer-implemented method 1100 for multimodal intent fusion in legal encounter scenarios. The method 1100 may be executed by the processor 410 of the system server 200, and more specifically by the event classification and escalation module 510 of the interaction analysis module 412. The flowchart employs traditional flowchart conventions, wherein rectangular process boxes represent operational steps and directional arrows indicate the flow of control through the method.

The method 1100 may begin at step 1110, which represents receiving, from a user computing device, a plurality of data streams. The plurality of data streams may comprise an audio stream comprising speech data, a visual stream comprising image data, and a positional stream comprising geographic coordinates. The event classification and escalation module 510 may receive the plurality of data streams from the user computing device 201 via the network 199 and the user communication module 416. The audio stream may comprise raw audio waveforms or compressed audio data captured by the microphone 302. The visual stream may comprise a sequence of image frames or compressed video data captured by the camera 301. The positional stream may comprise geographic coordinates, timestamps, velocity vectors, and heading information captured by the global positioning system receiver of the user computing device 201.

The method 1100 may proceed to step 1112, which represents processing the audio stream using an automatic speech recognition model to generate a text transcript. The speech capture and transcription module 520 may apply the automatic speech recognition model to the audio stream to convert speech data into timestamped text. The automatic speech recognition model may comprise a neural network-based model trained on speech data, and may support real-time or near-real-time transcription. The speech capture and transcription module 520 may further apply speaker diarization techniques to differentiate between speech produced by the user and speech produced by one or more other parties to the interaction. The resulting text transcript may comprise a sequence of words or phrases, each associated with a timestamp and a speaker identifier.

The method 1100 may proceed to step 1114, which represents processing the visual stream using an object detection model to identify visual entities and generate entity labels. The visual evidence capture and analysis module 530 may apply the object detection model to individual image frames extracted from the visual stream. In embodiments corresponding to dependent claim 19, the object detection model may be configured to identify at least one of law enforcement badges, law enforcement uniforms, law enforcement vehicles, and weapons. The object detection model may comprise a convolutional neural network-based model, such as a YOLO-based model or a Faster R-CNN-based model, trained on labeled image data comprising examples of law enforcement-related objects. For each identified visual entity, the object detection model may generate an entity label, a bounding box indicating the spatial location of the entity within the image frame, and a confidence score indicating the likelihood that the entity has been correctly identified. In embodiments corresponding to dependent claim 20, the object detection model may further comprise an optical character recognition component configured to extract text from the visual entities. The extracted text may comprise at least one of badge numbers, department names, and unit identifiers. The optical character recognition component may apply character recognition algorithms to regions of the image frame corresponding to identified badges or uniforms to extract alphanumeric text.

The method 1100 may proceed to step 1116, which represents processing the positional stream to extract location attributes. The event classification and escalation module 510 may parse the positional stream to extract geographic coordinates, timestamps, velocity vectors, and heading information. The event classification and escalation module 510 may further query the geospatial intelligence ledger stored in the data retention systems 190 using the geographic coordinates to retrieve location-specific incident metadata. The location attributes may comprise the geographic coordinates, a jurisdiction identifier corresponding to the geographic coordinates, and location-specific risk indicators derived from the geospatial intelligence ledger.

The method 1100 may proceed to step 1118, which represents fusing the text transcript, the entity labels, and the location attributes using a transformer-based architecture to generate a unified multimodal representation. The event classification and escalation module 510 may apply a transformer-based neural network to combine information from the text transcript, the entity labels, and the location attributes into a single unified representation. The transformer-based architecture may comprise a BERT-based architecture or a GPT-based architecture, and may employ attention mechanisms to weigh the relative importance of different modalities. The transformer-based architecture may receive as input a concatenated sequence comprising tokenized text from the text transcript, feature vectors representing the entity labels, and feature vectors representing the location attributes. The transformer-based architecture may apply self-attention layers to learn dependencies between elements of the input sequence and may generate as output a unified multimodal representation comprising a fixed-length feature vector.

The method 1100 may proceed to step 1120, which represents applying the transformer-based architecture to the unified multimodal representation to generate a probabilistic encounter classification. The event classification and escalation module 510 may apply a classification head to the unified multimodal representation to generate a probability distribution over a predefined set of encounter types. The probabilistic encounter classification may comprise at least one of a traffic stop classification, a detention classification, an investigation classification, and an arrest classification. Each classification may be associated with a confidence score representing the probability that the current interaction corresponds to that encounter type. The confidence scores for all encounter types may sum to one.

The method 1100 may proceed to step 1122, which represents selecting a classification from the probabilistic encounter classification based on the confidence score. The event classification and escalation module 510 may identify the encounter type having the highest confidence score and may select that encounter type as the final classification. In embodiments, the event classification and escalation module 510 may apply a confidence threshold, and may select a classification only if its confidence score exceeds the confidence threshold. If no classification exceeds the confidence threshold, the event classification and escalation module 510 may designate the encounter as unclassified and may continue monitoring.

The method 1100 may proceed to step 1124, which represents triggering, based on the selected classification, jurisdiction-specific legal guidance corresponding to the selected classification. The event classification and escalation module 510 may transmit the selected classification to the legal guidance module 414. The real-time legal guidance engine 610 may retrieve jurisdiction-specific legal rules from the pruned legal dataset corresponding to the selected classification and may generate guidance tailored to the encounter type. For example, if the selected classification is a traffic stop classification, the real-time legal guidance engine 610 may retrieve legal rules governing traffic stops in the identified jurisdiction and may generate guidance regarding rights during traffic stops. The real-time legal guidance engine 610 may transmit the jurisdiction-specific legal guidance to the user computing device 201 via the user communication module 416 for presentation to the user via the user interface manager 210, and the method 1100 may terminate or may return to step 1110 to continue processing additional data streams during the active session.

It will be readily apparent to one of ordinary skill in the relevant arts that other suitable modifications and adaptations to the methods and applications described herein can be made without departing from the scope of any of the embodiments.

It is to be understood that while certain embodiments have been illustrated and described herein, the claims are not to be limited to the specific forms or arrangement of parts described and shown. In the specification, there have been disclosed illustrative embodiments and, although specific terms are employed, they are used in a generic and descriptive sense only and not for purposes of limitation. Modifications and variations of the embodiments are possible in light of the above teachings. It is therefore to be understood that the embodiments may be practiced otherwise than as specifically described.

1. A system for providing jurisdiction-aware legal guidance during user interactions, the system comprising:
a user computing device comprising a processor, a camera, a microphone, and a global positioning system receiver;
a system server in communication with the user computing device via a network;
a legal database stored in a data retention system, the legal database comprising a plurality of jurisdiction-specific legal rules indexed by geographic region;
a geospatial intelligence ledger stored in a data retention system, the geospatial intelligence ledger comprising anonymized incident metadata indexed by geographic coordinates;
wherein the processor of the user computing device is configured to:
capture audio data via the microphone;
capture visual data via the camera;
obtain positional data via the global positioning system receiver, the positional data comprising geographic coordinates and a timestamp;
transmit the audio data, the visual data, and the positional data to the system server;
wherein the system server is configured to:
receive the audio data, the visual data, and the positional data from the user computing device;
query the geospatial intelligence ledger using the geographic coordinates to retrieve location-specific incident metadata;
filter the legal database based on the geographic coordinates to generate a pruned legal dataset comprising only jurisdiction-specific legal rules applicable to a jurisdiction corresponding to the geographic coordinates;
analyze the audio data, the visual data, and the positional data to generate a contextual assessment;
apply a legal weighting algorithm to the contextual assessment, the location-specific incident metadata, and the pruned legal dataset to generate prioritized guidance; and
transmit the prioritized guidance to the user computing device for presentation via a user interface.

2. The system of claim 1, wherein the system server is further configured to retrieve user-specific attributes from a secure user attribute vault, and wherein the legal weighting algorithm is applied to the contextual assessment, the location-specific incident metadata, the pruned legal dataset, and the user-specific attributes.

3. The system of claim 2, wherein the user-specific attributes comprise at least one of demographic data, firearm permit data, vehicle registration data, medical condition data, and prior interaction history data.

4. The system of claim 1, wherein filtering the legal database comprises:
identifying a hierarchical jurisdiction structure corresponding to the geographic coordinates, the hierarchical jurisdiction structure comprising at least one of federal jurisdiction, state jurisdiction, and local jurisdiction; and
retaining legal rules associated with each level of the hierarchical jurisdiction structure.

5. The system of claim 1, wherein the legal weighting algorithm comprises:
assigning a first weight to the contextual assessment;
assigning a second weight to the location-specific incident metadata;
assigning a third weight to the pruned legal dataset; and
computing a weighted score for each of a plurality of candidate guidance options based on the first weight, the second weight, and the third weight.

6. A computer-implemented method for preserving forensic integrity of multimodal evidence, the method comprising:
initiating a data capture session in response to a user activation event, the data capture session associated with a unique session identifier;
capturing, during the data capture session, a plurality of data streams comprising:
an audio stream from at least one microphone;
a visual stream from at least one camera; and
a positional stream from at least one global positioning system receiver;
assigning, by a temporal alignment module, synchronized timestamps to data segments from each of the plurality of data streams using a centralized time-stamping authority;
segmenting the plurality of data streams into a plurality of media fragments, each media fragment associated with one of the synchronized timestamps;
applying a cryptographic hash function to each of the plurality of media fragments to generate a corresponding hash value;
generating a chain-of-custody log comprising the unique session identifier, the synchronized timestamps, and the hash values; and
committing the plurality of media fragments and the chain-of-custody log to a write-once-read-many storage architecture to prevent post-capture modification.

7. The method of claim 6, wherein the cryptographic hash function comprises a SHA-256 hash function.

8. The method of claim 6, wherein the plurality of data streams are captured from a plurality of devices comprising at least two of a mobile device, a dash-mounted camera, a wearable device, and an internet-of-things sensor.

9. The method of claim 6, wherein the centralized time-stamping authority synchronizes timestamps using a Network Time Protocol server.

10. The method of claim 6, wherein each media fragment has a duration between one second and sixty seconds.

11-13. (canceled)

14. A system for aggregating and utilizing crowdsourced geospatial intelligence, the system comprising:
a plurality of user computing devices, each user computing device configured to capture interaction data during a user interaction session, the interaction data comprising audio data, visual data, and positional data;
a geospatial intelligence ledger stored in a data retention system, the geospatial intelligence ledger comprising a plurality of incident records, each incident record indexed by geographic coordinates and comprising anonymized metadata derived from prior user interaction sessions;
a predictive logic engine configured to:
receive current positional data from a first user computing device of the plurality of user computing devices, the current positional data comprising current geographic coordinates;
query the geospatial intelligence ledger using the current geographic coordinates to retrieve a subset of the plurality of incident records within a defined geofence radius of the current geographic coordinates;
analyze the subset of the plurality of incident records to determine a location-specific risk profile;
generate, based on the location-specific risk profile, primed guidance tailored to the current geographic coordinates; and
transmit the primed guidance to the first user computing device;
wherein the system is further configured to:
receive completed interaction data from a second user computing device of the plurality of user computing devices upon completion of a user interaction session;
anonymize the completed interaction data to remove personally identifiable information;
extract incident metadata from the anonymized completed interaction data, the incident metadata comprising at least one of encounter type, timestamp, and legal violation indicator; and
commit the incident metadata to the geospatial intelligence ledger indexed by geographic coordinates associated with the completed interaction data.

15. The system of claim 14, wherein the defined geofence radius is between 100 meters and 10 kilometers.

16. The system of claim 14, wherein the predictive logic engine is further configured to:
monitor the geospatial intelligence ledger for high-density incident indicators within a geographic area; and
generate a heuristic trigger when a number of incidents within the geographic area exceeds a predefined threshold.

17-24. (canceled)
